(19) United States
(12) Patent Application Publication
(10) Pub. No.: US 2025/0021570 A1
(43) Pub. Date: Jan. 16, 2025

(54) INFORMATION PROCESSING APPARATUS, ANALYSIS SYSTEM, DATA GENERATION METHOD, AND NON-TRANSITORY COMPUTER READABLE MEDIUM

(71) Applicant: NEC Corporation, Minato-ku, Tokyo (JP)

(72) Inventor: Tingting Dong, Tokyo (JP)

(73) Assignee: NEC Corporation, Minato-ku, Tokyo (JP)

(21) Appl. No.: 18/700,320

(22) PCT Filed: Nov. 8, 2021
(86) PCT No.: PCT/JP2021/040990

§ 371 Date: Apr. 11, 2024

(51) Int. Cl. G06F 16/2457

(52) U.S. Cl. CPC G06F 16/24578

(57) ABSTRACT

An information processing apparatus includes a management unit managing objects, at least one attribute, and a certainty factor in association with one another, a calculation unit using an attribute designated as a search condition and a certainty factor that can be designated as a search condition for the attribute, and a certainty factor managed in association with an attribute identical or similar to an attribute designated as a search condition, thereby calculating a score indicating a matching degree of an object with a search condition, a sorting unit sorting scores and arranging objects in order of sorted scores, a specifying unit specifying a certainty factor changing the object order, based on a shift in scores of the objects, and a display control unit generating display data associating an attribute designated as a search condition with a certainty factor changing the object order and displaying resultant.

### TECHNICAL FIELD

The present disclosure relates to an information processing apparatus, an analysis system, a data generation method, and a program.

### BACKGROUND ART

In recent years, surveillance cameras have been installed in various places due to widespread use of surveillance cameras. Videos taken by the surveillance cameras are used, for example, in investigations of various incidents, or the like. Specifically, the police may often investigate a suspicious person by using eyewitness information of a certain suspicious person from a huge amount of videos.

Patent Literature 1 discloses a configuration of an information processing apparatus that searches for a target person according to search conditions for which attributes are designated in categories of gender, hair color, clothing color, and the like. The information processing apparatus in Patent Literature 1 designates not only a search condition for which an attribute is designated, but also a certainty factor representing likelihood that the search condition is satisfied, and displays a person who satisfies the search condition and the certainty factor. For example, when male is designated as an attribute and a certainty factor is designated to be 90%, the information processing apparatus displays, as a search result, a person with a certainty factor of 90% or greater about being classified as “male”. In other words, the information processing apparatus does not display a person with a certainty factor of less than 90% about being classified as “male”.

### CITATION LIST

### Patent Literature

[Patent Literature 1] International Patent Publication No. WO 2020/255307

### SUMMARY OF INVENTION

### Technical Problem

By designating the attribute and the certainty factor being disclosed in Patent Literature 1 and rearranging and displaying persons exceeding the designated certainty factor in descending order of certainty factors, it is possible to acquire a search result that facilitates analysis by a user. For example, it is possible to analyze relevance between a certainty factor and a search result by clarifying an influence of a change in the certainty factor on a change in the search result. In such a case, it is desired to develop a tool, an apparatus, or the like for easily recognizing the influence of a change in the certainty factor on a change in the search result.

One object of the present disclosure is to provide an information processing apparatus, an analysis system, a data generation method, and a program that are capable of easily recognizing an influence of a change in certainty factor on a change in search result.

### Solution to Problem

An information processing apparatus according to a first aspect of the present disclosure includes: a management means for managing a plurality of objects, at least one attribute by which each of the objects is classified, and a certainty factor indicating a probability that the object has the attribute, in association with one another; a calculation means for using an attribute being designated as a search condition, a certainty factor that can be designated as a search condition for the attribute, and a certainty factor being managed in association with an attribute being identical or similar to the attribute designated as the search condition, and thereby calculating a score indicating a matching degree of the object with respect to the search condition; a sorting means for sorting the scores and arranging the plurality of objects in order of the sorted scores; a specifying means for specifying a certainty factor that changes an order of the objects, based on a shift in the scores of the plurality of objects that change depending on a shift in the certainty factor that can be designated as the search condition; and a display control means for generating display data for displaying the attribute designated as the search condition and the certainty factor that changes an order of the objects in association with each other.

An analysis system according to a second aspect of the present disclosure includes an information processing apparatus and a display device. The information processing apparatus includes: a management means for managing a plurality of objects, at least one attribute by which each of the objects is classified, and a certainty factor indicating a probability that the object has the attribute, in association with one another; a calculation means for using an attribute designated as a search condition, a certainty factor that can be designated as a search condition for the attribute, and a certainty factor being managed in association with an attribute identical or similar to the attribute designated as the search condition, and thereby calculating a score indicating a matching degree of the object with respect to the search condition; a sorting means for sorting the scores and arranging the plurality of objects in order of the sorted scores; a specifying means for specifying a certainty factor that changes an order of the objects, based on a shift in the scores of the plurality of objects that change depending on a shift in the certainty factor that can be designated as the search condition; and a display control means for generating display data for displaying the attribute designated as the search condition and the certainty factor that changes an order of the objects in association with each other, and the display device displays the display data.

A data generation method according to a third aspect of the present disclosure includes: managing a plurality of objects, at least one attribute by which each of the objects is classified, and a certainty factor indicating a probability that the object has the attribute, in association with one another; using an attribute designated as a search condition, a certainty factor that can be designated as a search condition for the attribute, and a certainty factor being managed in association with an attribute identical or similar to the attribute designated as the search condition, and thereby calculating a score indicating a matching degree of the object with respect to the search condition; sorting the scores and arranging the plurality of objects in order of the sorted scores; specifying a certainty factor that changes an order of the objects, based on a shift in the scores of the plurality of objects that change depending on a shift in the certainty factor that can be designated as the search condition; and generating display data for displaying the attribute designated as the search condition and a certainty factor that changes an order of the objects in association with each other.

A program according to a fourth aspect of the present disclosure causes a computer to execute: managing a plurality of objects, at least one attribute by which each of the objects is classified, and a certainty factor indicating a probability that the object has the attribute, in association with one another; using an attribute designated as a search condition, a certainty factor that can be designated as a search condition for the attribute, and a certainty factor being managed in association with an attribute identical or similar to the attribute designated as the search condition, and thereby calculating a score indicating a matching degree of the object with respect to the search condition; sorting the scores and arranging the plurality of objects in order of the sorted scores; specifying a certainty factor that changes an order of the objects, based on a shift in the scores of the plurality of objects that change depending on a shift in the certainty factor that can be designated as the search condition; and generating display data for displaying the attribute designated as the search condition and the certainty factor that changes an order of the objects in association with each other.

According to the present disclosure, it is possible to provide an information processing apparatus, an analysis system, a data generation method, and a program that are capable of easily recognizing an influence of a change in certainty factor on a change in search result.

### BRIEF DESCRIPTION OF DRAWINGS

FIG. 1 is a configuration diagram of an information processing apparatus according to a first example embodiment;

FIG. 2 is a flowchart illustrating a flow of processing of data generation method according to the first example embodiment;

FIG. 3 is a configuration diagram of an information processing apparatus according to a second example embodiment;

FIG. 4 is a diagram illustrating data managed by a management unit according to the second example embodiment;

FIG. 5 is a diagram illustrating a screen image according to the second example embodiment;

FIG. 6 is a diagram for explaining a change in order in a result display region according to the second example embodiment;

FIG. 7 is a diagram illustrating a relationship between a certainty factor and a score of each object according to the second example embodiment;

FIG. 8 is a diagram illustrating a transition between ranking of an object at a time when the certainty factor is 0 and ranking of the object at a time when the certainty factor is 1 according to the second example embodiment;

FIG. 9 is a flowchart illustrating a flow of processing of specifying an intersection point of line segments according to the second example embodiment;

FIG. 10 is a diagram illustrating a screen image according to the second example embodiment; and

FIG. 11 is a configuration diagram of an information processing apparatus according to each example embodiment.

### EXAMPLE EMBODIMENT

### First Example Embodiment

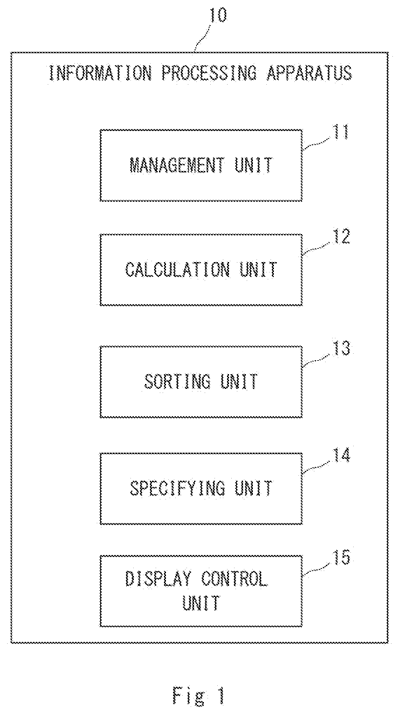

Hereinafter, example embodiments of the present invention will be explained with reference to the drawings. A configuration example of an information processing apparatus 10 according to a first example embodiment will be explained with reference to FIG. 1. The information processing apparatus 10 may be a computer apparatus that operates when a processor executes a program stored in a memory.

The information processing apparatus 10 includes a management unit 11, a calculation unit 12, a sorting unit 13, a specifying unit 14, and a display control unit 15. The management unit 11, the calculation unit 12, the sorting unit 13, the specifying unit 14, and the display control unit 15 may be software or modules that perform processing when the processor executes a program stored in a memory. Alternatively, the management unit 11, the calculation unit 12, the sorting unit 13, the specifying unit 14, and the display control unit 15 may be hardware such as a circuit or a chip.

The management unit 11 manages a plurality of objects, at least one attribute in which each of the objects is classified, and a certainty factor indicating a probability that the object has an attribute in association with each other.

The object may be a person, an animal, a building, a structure, or the like. Alternatively, the object may be a moving means such as a vehicle, a bicycle, or a train.

The attribute by which the object is classified may be natures to be classified within categories such as gender, age, color of clothing, or the like. For example, in the category of gender, male and female may be used as attributes. In the category of age, generations may be used as attributes, such as teens, twenties, or thirties, or age may be used. In the category of clothing color, colors of red, blue, yellow, or the like may be used. In addition, for example, colors of dark red, deep red, or the like may be used which are acquired by further classification of the same color in the category of clothing color.

The certainty factor indicates a probability that the object has the attribute, or the certainty factor may be rephrased to indicate likelihood that the object has a designated attribute. The certainty factor may be indicated as, for example, a unit in percentage (%), or may be indicated by using a decimal of 0 or greater and 1 or less. When the certainty factor is indicated by using a decimal of 0 or greater and 1 or less, the certainty factor becomes higher as the value increases.

The management unit 11 may hold a database in which an object, an attribute by which the object is classified, and a certainty factor indicating a probability that the object has the attribute are associated with each other.

The calculation unit 12 calculates a score indicating a matching degree of the object with respect to a search condition. Specifically, the calculation unit 12 uses an attribute designated as a search condition and a certainty factor that can be designated as a search condition for the attribute, and a certainty factor that is managed in association with an attribute identical or similar to the attribute designated as the search condition.

The search condition may be input by, for example, a user or the like of the information processing apparatus 10. Alternatively, the search condition may be input from another computer apparatus to the information processing apparatus 10 via a network. Alternatively, the information processing apparatus may determine the search condition by analyzing voice, text, an image, or the like.

The certainty factor that can be designated as a search condition may be, for example, a value included in a width of a value that can be set as a certainty factor. For example, when the certainty factor is indicated as a percentage, the certainty factor that can be designated as a search condition, may be a value from 0 to 1. Alternatively, the certainty factor that can be designated as a search condition may be any value between 0 and 1 to any value between 0 and 1.

The management unit 11 manages the certainty factor associated with an attribute that is identical or similar to the attribute designated as the search condition. In other words, the calculation unit 12 uses the attribute designated as the search condition, thereby extracting the certainty factor associated with an attribute that is identical or similar to the attribute designated as the search condition, from the database held by the management unit 11.

The score indicating the matching degree of the object with respect to the search condition may be set such that the matching degree of the object with respect to the search condition becomes higher as the value increases. For example, when a plurality of attributes and the certainty factors thereof are designated as search conditions, the calculation unit 12 may calculate an overall score relating to the object by totalizing score values calculated for each attribute. In other words, the score relating to the object is a value acquired by considering a plurality of attributes or combining a plurality of attributes.

The sorting unit 13 sorts the scores and arranges the plurality of objects in order of the sorted scores. Sorting the scores may be rearranging in descending order of scores, or may be rearranging in ascending order of scores. The sorting unit 13 rearranging a plurality of objects may be, for example, the sorting unit 13 creating a ranking of a plurality of objects in order of the scores.

The specifying unit 14 specifies the certainty factor that changes an order of the objects, based on a shift in the scores, of the plurality of objects, that change depending on a shift in the certainty factor that can be designated as the search condition. When the certainty factor designated as the search condition changes, the score of each object also changes. Therefore, the order of the objects arranged in order of the scores also changes as the scores of the objects change. The specifying unit 14 specifies the certainty factor designated when the order of the objects is changed.

The display control unit 15 generates display data for displaying an attribute designated as a search condition in association with a certainty factor that changes an order of the objects. A display device used as a device integrated with the information processing device 10 may display display data, and a display device that has received the display data via a network may display the display data.

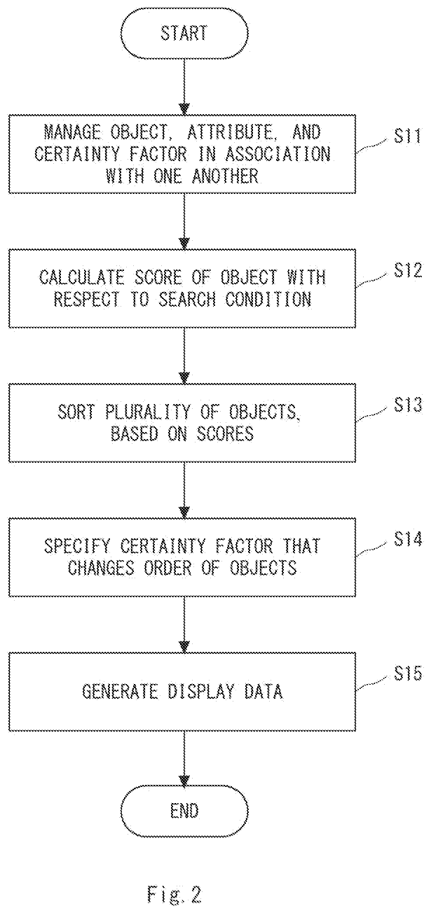

Subsequently, a flow of processing of a data generation method in the information processing apparatus according to the first example embodiment will be explained with reference to FIG. 2.

First, the management unit 11 manages a plurality of objects, at least one attribute by which each of the objects is classified, and a certainty factor indicating a probability that the object has the attribute in association with each other (S11). Next, the calculation unit 12 calculates a score by using an attribute designated as a search condition and a certainty factor that can be designated as a search condition for the attribute, and a certainty factor that is managed in association with an attribute identical or similar to the attribute designated as the search condition. The score indicates the matching degree of the object with respect to the search condition (S12).

Next, the sorting unit 13 sorts the scores and arranges the plurality of objects in order of the sorted scores (S13). Next, the specifying unit 14 specifies the certainty factor that changes an order of the objects, based on a shift in the scores, of the plurality of objects, that change depending on a shift in the certainty factor that can be designated as the search condition (S14). Next, the display control unit 15 generates display data for displaying the attribute designated as the search condition and the certainty factor that changes an order of the object in association with each other (S15).

As described above, the information processing apparatus 10 specifies the certainty factor that is to change an order of the objects arranged in order of the scores when the certainty factor of the designated attribute changes. Further, the information processing apparatus 10 generates display data for displaying a certainty factor that is to change an order of the objects on the display device. Thus, an analyst or the like who analyzes the data can easily recognize an influence of a change in the certainty factor on the order of the objects arranged in order of the scores by visually recognizing the display data.

In FIG. 1, a configuration in which the management unit 11 is included in the information processing apparatus 10 has been explained, but for example, the management unit 11 may be included in a device different from the information processing apparatus 10. In this case, the calculation unit 12 of the information processing apparatus 10 may acquire information managed by the management unit 11 included in another apparatus via the network.

### Second Example Embodiment

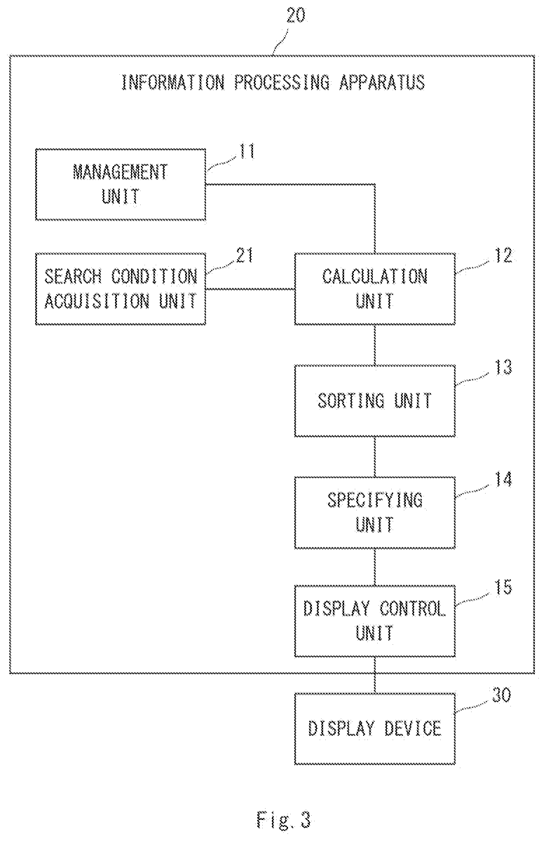

Subsequently, a configuration example of an information processing apparatus 20 according to a second example embodiment will be explained with reference to FIG. 3. The information processing apparatus 20 has a configuration in which a search condition acquisition unit 21 is added to the information processing apparatus 10. The information processing apparatus 20 is connected to a display device 30. The display device 30 is used integrally with the information processing apparatus 20, i.e., the display device 30 may be included in the information processing apparatus 20. Alternatively, the information processing apparatus 20 may communicate with the display apparatus 30 via a network. The display device 30 displays the received display data. The display device 30 may be referred to as, for example, a display device or the like.

A management unit 11, a calculation unit 12, a sorting unit 13, a specifying unit 14, and a display control unit 15 constituting the information processing apparatus 20 are similar to those of the information processing apparatus 10, and thus detailed description thereof will be omitted. In the following, explanation will be given with respect to detailed functions, operations, and the like, such as functions and operations of the information processing apparatus 20, which are different from those of the information processing apparatus 10, or such as functions and operations of the information processing apparatus 20 and the information processing apparatus 10.

The search condition acquisition unit 21 acquires a search condition. The search condition acquisition unit 21 may acquire, for example, a search condition being input by a user of the information processing apparatus 20 via an input interface or the like. The user may input an attribute and a certainty factor by performing text input or voice input using, for example, a keyboard, a touch panel, a microphone, or the like. For example, when the user inputs a search condition, an eyewitness of a person to be searched may determine a certainty factor, which is an attribute by which the person to be searched is classified. In this case, the search condition to be input is determined according to the subjectivity of the eyewitness.

Alternatively, the search condition acquisition unit 21 may specify the search condition by using an input image. For example, when a search or an investigation for a certain person is performed, the user inputs image data, in which such a person appears, to the information processing apparatus 20. The search condition acquisition unit 21 may specify an attribute of the person displayed in the image and further calculate a certainty factor of the attribute, by executing image analysis processing or image recognition processing on the input image data.

The image analysis processing or the image recognition processing may be executed by using, for example, a plurality of pieces of image data, in which a person is displayed, as training data, and using a trained model generated for learning an attribute relating to the person and a certainty factor indicating a probability that the person has the attribute. By applying the input image data to the generated trained model, the search condition acquisition unit 21 acquires the attribute of the person displayed in the image and the certainty factor indicating the probability that the person has the attribute.

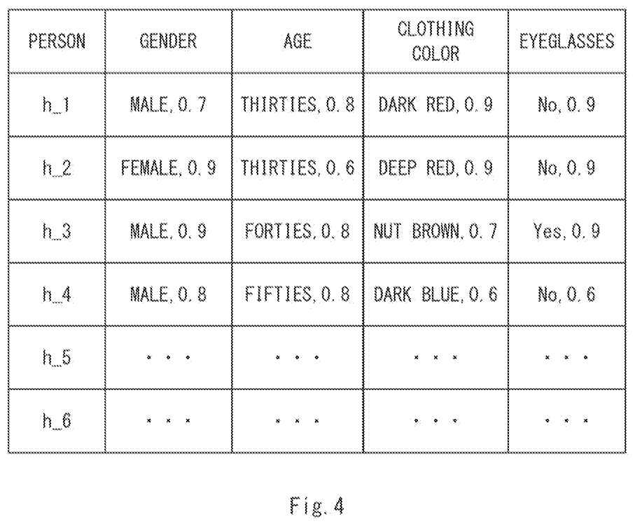

Subsequently, data to be managed by the management unit 11 will be explained with reference to FIG. 4. FIG. 4 illustrates a database in which a person is used as an object and attributes of the person are managed. Symbols h_1 to h_6 shown in a column of persons indicate identification information for identifying a person. In a category of gender, for example, an attribute of male or female is set. In a category of age, for example, a generation of thirties, forties, fifties, or the like is set. In a category of clothing color, a color of dark red, deep red, nut brown, and deep blue or the like is set. In a category of eyeglasses, Yes is set when the person is wearing eyeglasses, and No is set when the person is not wearing eyeglasses. A numerical value illustrated next to each of the attributes indicates a certainty factor indicating a probability that each person has the attribute or likelihood that each person has the attribute. In addition, the category of clothing color may be divided into an upper body clothing color, a lower body clothing color, a hat color, a shoe color, and the like. An attribute and a certainty factor may be set for each of the upper body clothing color, the lower body clothing color, the hat color, and the shoe color.

As illustrated in FIG. 4, for example, the person h_1 has a certainty factor of 0.7 that he is male, has a certainty factor of 0.8 that he is in thirties, has a certainty factor of 0.9 that he is wearing dark red clothes, and has a certainty factor of 0.9 that he is not wearing eyeglasses. Similarly for other persons, attributes and certainty factors are associated with each other. The certainty factor represented by using a decimal of 1 or less indicates higher as the value of the certainty factor increases. To put it another way, with respect to the person h_1, the probability of being a male is 70%, and the probability of being in thirties is 80%, for example.

Herein, the persons h_1 to h_6 may be persons appearing in a video or the like taken by a surveillance camera. For example, the management unit 11 may acquire video data taken by the surveillance camera, and specify a plurality of persons, attributes relating to the person, and certainty factors of the attributes, from the video data. Specifically, similarly to the search condition acquisition unit 21, the management unit 11 may apply the video data to the trained model and may acquire the attribute of the person included in the video and the certainty factor indicating the probability that the person has the attribute. Further, the management unit 11 may manage the video, in which each of the persons appears, in the form of a still image or a moving image. The management unit 11 may manage the video, in which each of the persons appears, and the attribute and certainty factor of each of the persons appearing in the video in association with each other. Furthermore, the management unit 11 may manage a frame image constituting the video, in which each of the persons appears, and the attribute and certainty factor of each of the persons appearing in the frame image in association with each other. For example, when the person h_1 is designated, the management unit 11 may extract still image data in which the person h_1 appears.

Alternatively, the analysis processing of the video data taken by the surveillance camera may be executed in a computer apparatus different from the information processing apparatus 20, and an attribute of a person included in the video data and a certainty factor indicating a probability that the person has the attribute may be specified. In this case, the management unit 11 may acquire, from the computer apparatus that has analyzed the video data, the attribute of the person included in the video data and the certainty factor indicating the probability that the person has the attribute, via the network. Alternatively, the user of the information processing apparatus 20 may input an analysis result of the computer apparatus, which has analyzed the video data, to the information processing apparatus 20. In addition, the management unit 11 may acquire the video data, in which the person appears, from the computer apparatus that has analyzed the video data.

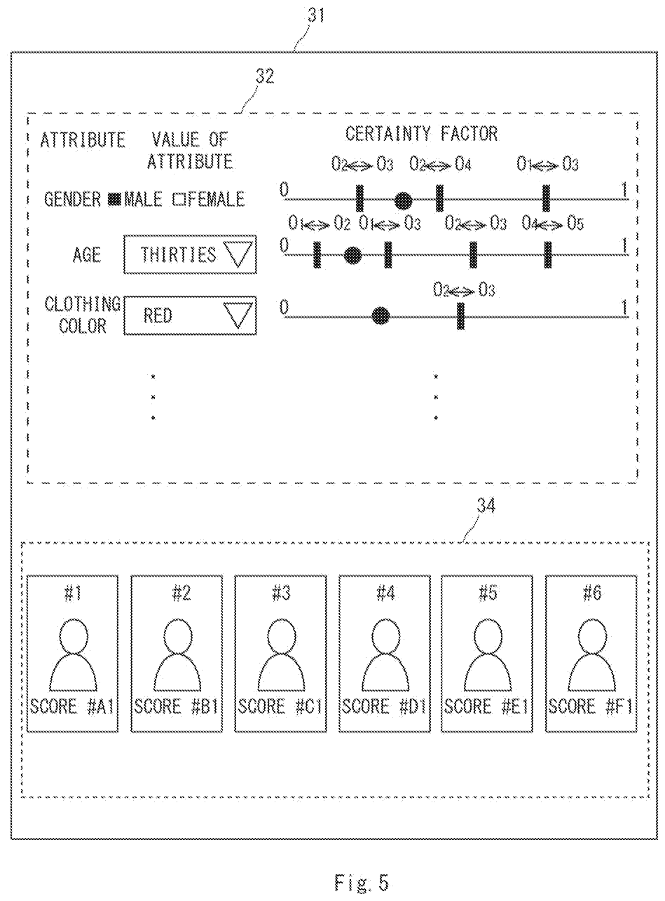

Subsequently, a screen image to be generated by the display control unit 15 will be explained with reference to FIG. 5. FIG. 5 illustrates a display screen 31 displayed on the display device 30. The display screen 31 includes a search condition designating region 32 and a result display region 34. For example, the user of the information processing apparatus 20 sets the attribute and the certainty factor in the search condition designating region 32. FIG. 5 illustrates that the user of the information processing apparatus 20 sets a male and thirties as attributes, and further illustrates that red is set as a color of clothes.

Further, FIG. 5 illustrates that the user of the information processing apparatus 20 sets the certainty factor in each attribute by using a slide bar in which a numerical value is set from 0 to 1. A black circle on the slide bar indicates the certainty factor set by the user. The user can change the certainty factor in each attribute by moving the black circle on the slide bar over a number from 0 to 1.

For example, the user sets an attribute and a certainty factor of a person to be searched according to an instruction from an eyewitness who has witnessed the person to be searched. In a case where the search condition is specified by using the input image, the input image may be displayed in the search condition designating region 32. In this case, the certainty factor relating to each attribute is set based on the input image.

The result display region 34 indicates that the person to be searched is arranged in order of the scores calculated based on the certainty factor set in each attribute. For example, the result display region 34 indicates that the leftmost person has the highest score, and that the person having the smaller score is displayed as advancing rightward. #1 to #6 are identification information for identifying a person. For example, #1 to #6 indicate h_1 to h_6.

A black rectangle on the slide bar of the search condition designating region 32 indicates a value of a certainty factor that changes an order of the persons displayed in the result display region 34. In other words, the rectangle on the slide bar indicates a threshold value of the certainty factor that changes an order of the persons displayed in the result display region 34. Further, the threshold of the certainty factor may be displayed on a bar different from a certainty factor setting slide bar. For example, a certainty factor threshold bar is further displayed below the certainty factor setting slide bar.

For example, it is assumed that the certainty factor of the attribute of the age and the clothing color is a position of the black circle in FIG. 5. In this case, FIG. 5 illustrates that, when the certainty factor of gender is moved from 0 to 1, the order of the persons displayed in the result display region 34 is changed in three values on a slide bar of gender in the search condition designating region 32. O₁ to O₅ displayed in the search condition designating region 32 indicate #1 to #5. Also, when the certainty factor of at least one of attributes of the age and clothing color is in a different position from the position illustrated in FIG. 5, the position of the threshold value illustrated on the gender slide bar also changes from the position illustrated in FIG. 5. Further, when the certainty factor of the attribute of age is in a position different from the position illustrated in FIG. 5, the position of the threshold value illustrated on a slide bar of the attributes of gender and age may also change from the position illustrated in FIG. 5. Alternatively, when any one of the certainty factors of the plurality of attributes set in the search condition is changed, the position of the threshold value indicated on the slide bar of all the attributes set in the search condition may be changed.

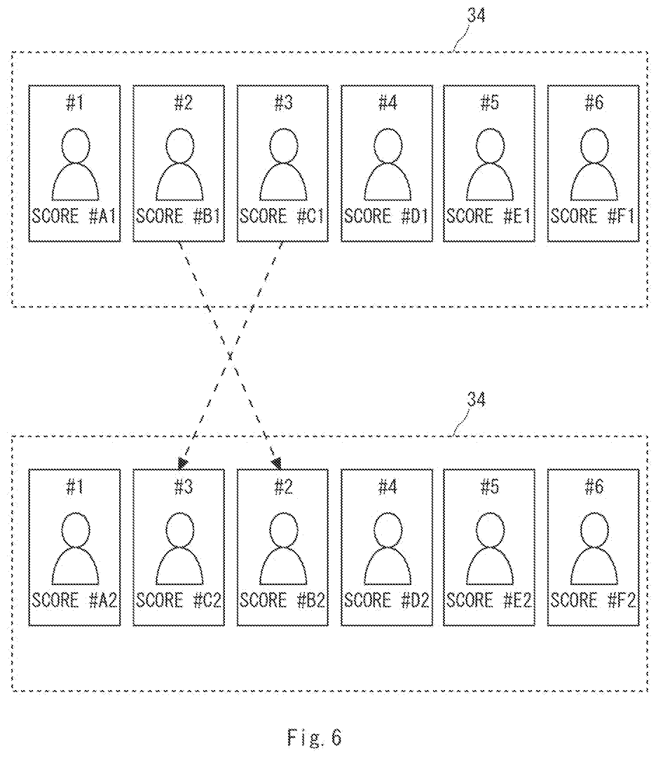

For example, it indicates that the order of #2 and #3 is changed in the value of the certainty factor indicated by the leftmost black rectangle on the slide bar of gender. Specifically, as illustrated in FIG. 6, the display order of #2 and #3 in the result display region 34 is changed. The above figure of FIG. 6 illustrates the order when the certainty factor is present to the left of the leftmost black rectangle on the gender slide bar. The figure below in FIG. 6 illustrates the order when the certainty factor is present to the right of the leftmost black rectangle on the gender slide bar. Further, it illustrates that the order of #2 and #4 is changed in the value of the certainty factor indicated by the middle black rectangle on the slide bar of the gender and the order of #1 and #3 is changed in the value of the certainty factor indicated by the rightmost black rectangle.

Similarly to gender, the black rectangle on an age slide bar indicates a value of the certainty factor that changes an order of the persons displayed in the result display region 34. In other words, the value of the certainty factor that changes an order of the persons displayed in the result display region 34 is illustrated on the assumption that the certainty factor of the gender and the clothing color is in a position of the black circle in FIG. 5. A black rectangle on a clothing-colored slide bar is similar to gender and age.

Next, score calculation processing to be executed by the calculation unit 12 will be explained. The calculation unit 12 calculates a score for each person managed by the management unit 11 by using Formula 1 below.

$$S ( h ) = {\sum }_{j = 1}^{m} {p}_{j}^{q} \times {p}_{j}^{h} \times Sim ( {f}_{j}^{q} , {f}_{j}^{h} ) \qquad ( 1 )$$

pⱼ^{q}: a certainty factor of a j-th attribute of a search condition (query condition)
pⱼ^{h}: a certainty factor of a j-th attribute of a search target
Sim(fⱼ^{q}, fⱼ^{h}): similarity between the j-th attribute of the search condition and the j-th attribute of the search target

The j-th attribute of the search condition is, for example, an attribute set for the i-th category displayed in the search condition designating region 32 in FIG. 5. In FIG. 5, counting is sequentially performed from the category displayed on the top. In FIG. 5, for example, a male set for a first category is a first attribute, and an age in thirties set for a second category is a second attribute.

The j-th attribute of the search target is, for example, an attribute set for the j-th category shown in the database in FIG. 4. In FIG. 4, counting is sequentially performed from the category shown on the left, excluding the person. In FIG. 4, for example, the attribute set for the category of gender is a first attribute, an attribute set for the category of age is a second attribute, an attribute set for the category of clothing color is a third attribute, and an attribute set for the category of eyeglasses is a fourth attribute.

The order of the categories displayed in the search condition designating region 32 in FIG. 5 and the order of the categories shown in the database in FIG. 4 may be determined in advance in such a way that the same categories are set in the same order. In other words, the first category displayed in the search condition designating region in FIG. 5 and the first category excluding the category of the person shown in the database in FIG. 4 may be determined as the category of gender in advance.

As for Sim(fⱼ^{q}, fⱼ^{h}), for example, an existing similarity function may be used, or it may be predefined by the user. For example, as in Sim(male, male)=1.0, Sim(red, dark red)=0.95, Sim(red, deep red)=0.70, similarity values may be set for all combinations of attributes that can be set in the same category. 1.0 set as similarity indicates that the attributes match, and the similarity between two attributes decreases as the value decreases from 1.0.

In addition, as for Sim(fⱼ^{q}, fⱼ^{h}), the similarity between the j-th attribute of the search condition and the j-th attribute of the search target is calculated, and the similarity between attributes set in different categories may not be calculated. In other words, the similarity such as Sim(male, deep blue) is not calculated. Alternatively, the similarity between attributes set in different categories may be set to a low value. Further, when two attributes clearly have no similarity even if such attributes can be set in the same category, the similarity may not be calculated. For example, similarity need not be calculated for Sim(teens, fifties). Alternatively, the similarity between two attributes, which can be set in the same category but clearly have no similarity may be set to be a low value.

For example, it is assumed that (male, 0.9), (thirties, 0.8), (forties, 0.2), and (red, 0.7) are input as search conditions in the search condition designating region 32 in FIG. 5. In the parenthesis, the left side indicates the attribute, and the right side indicates the certainty factor. Further, in FIG. 5, for example, only the age in thirties is designated in the category of age, but a plurality of generations may be set.

In this case, the calculation unit 12 calculates the scores of the persons h_1 to h_4 managed in FIG. 4 as follows. The calculation of scores of h_5 and h_6 is omitted.

S(h₁)=0.9×0.7×Sim(male, male)+0.8×0.8×Sim(thirties, thirties)+0.7×0.9×Sim(red, dark red)=0.9×0.7×1.0+0.8×0.8×1.0+0.7×0.9×0.95=1.8685

S(h₂)=0.9×0.9×Sim(male, female)+0.8×0.6×Sim(thirties, thirties)+0.7×0.9×Sim(red, deep red)=0.9×0.9×0.0+0.8×0.6×1.0+0.7×0.9×0.7=0.921

S(h₃)=0.9×0.9×Sim(male, male)+0.2×0.8×Sim(forties, forties)+0.7×0.7×Sim(red, nut brown)=0.9×0.9×1.0+0.2×0.8×1.0+0.7×0.7×0.8=1.362

S(h₄)=0.9×0.8×Sim(male, male)+0.7×0.6×Sim(red, deep blue)=0.9×0.8×1.0+0.7×0.6×0.0=0.72

As for the persons h_5 and h_6, it is assumed that h_5 has a higher score than h_6, and h_5 and h_6 have a lower score than h_4. At this time, the scores of the persons h_1 to h_6 are h_1, h_3, h_2, h_4, h_5, and h_6 in descending order of score. Accordingly, the sorting unit 13 sorts h_1 to h_6 in descending order of score, and the display control unit 15 generates display data in such a way as to display h_1, h_3, h_2, h_4, h_5, and h_6 in the result display region 34 in this order.

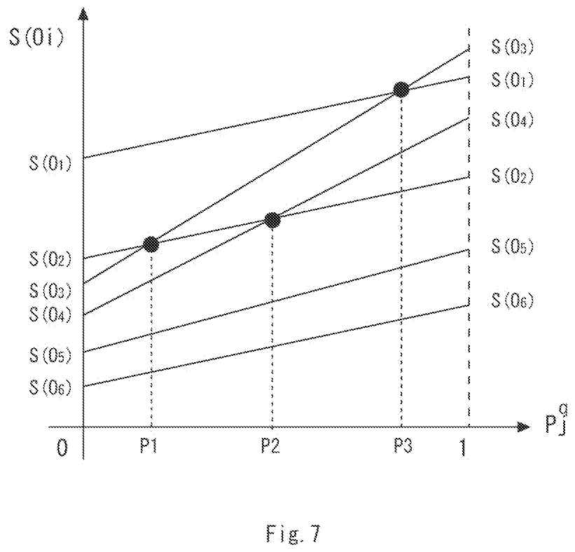

Subsequently, a relation between the certainty factor (pⱼ^{q}) of an attribute designated as a search target and the score of each object will be explained with reference to FIG. 7. S(O₁) indicates the score of the person h_1 calculated by the calculation unit 12. S(O₂) to S(O₆) also indicate the scores of the persons h_2 to h_6. FIG. 7 illustrates a shift in the score of each person in a case where, for example, on the assumption that a male, thirties, and a red clothing are designated as attributes, and that the certainty factor of the thirties and the red clothing is in a position of a black circle in FIG. 5, a certainty factor of the male is shifted from 0 to 1.

In the sorting unit 13, the order of scores when the attribute is a male and the certainty factor of the male is 0 is arranged in descending order of the h_1, h_2, h_3, h_4, h_5, and h_6. In addition, as for the order of scores when the attribute is a male and the certainty factor thereof is 1, the scores are arranged in descending order of the h_3, h_1, h_4, h_2, h_5, and h_6 in the sorting unit 13.

P1, P2, and P3 indicate the certainty factor of an intersection point of the line segment indicating a shift in the score of each person. For example, the person h_2 and the person h_3 are switched in order in a certainty factor P1. In addition, the person h_2 and the person h_4 are switched in order in a certainty factor P2. The person h_1 and the person h_3 are switched in order in a certainty factor P3.

The specifying unit 14 may specify the intersection point of the line segments by solving an equation using an equation of a straight line indicating each line segment and y=ax+b (a and b are positive numbers). For example, the specifying unit 14 may specify the intersection point of the line segments by specifying the line segments having the intersection point and solving the equation using the equation of the straight line of the specified line segment. In other words, the specifying unit 14 may not solve equations of all combinations of line segments, but may solve only the equations of combinations of line segments having intersection points. Alternatively, the specifying unit 14 may specify the intersection point of the line segments by using Bentley-Ottmann algorithm.

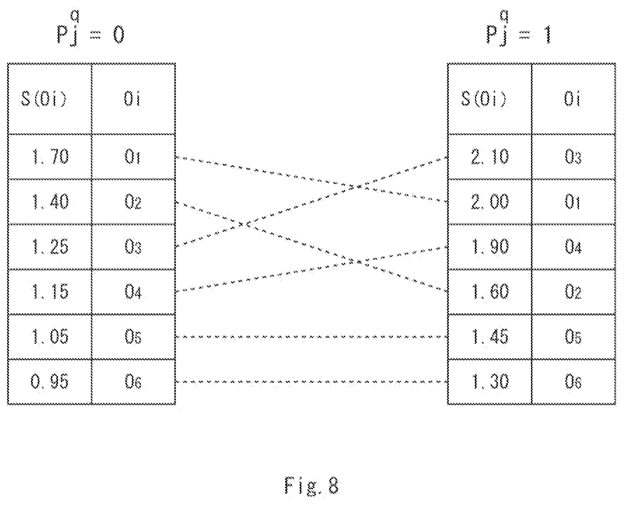

FIG. 8 illustrates a transition in ranking of the objects at the time when the certainty factor is 0 and ranking of the objects at the time when the certainty factor is 1. Herein, processing of specifying a combination of line segments having intersection points by the specifying unit 14 will be explained with reference to FIG. 8.

The specifying unit 14 selects h_1 having the highest ranking of the object at the time when the certainty factor is 0. Further, the specifying unit 14 extracts an object having a lower ranking than h_1 at the time when the certainty factor is 0 and a higher ranking than h_1 at the time when the certainty factor is 1. Herein, h_3 exists as the relevant object. Similar to h_1, the specifying unit 14 extracts the relevant objects for h_2 to h_6 as well. Herein, h_3 and h_4 are extracted as objects having a lower ranking than h_2 at the time when the certainty factor is 0 and having higher ranking than h_2 at the time when the certainty factor is 1.

The specifying unit 14 calculates the intersection point of the line segment of h_1 and the line segment of h_3, and further specifies the certainty factor that changes an order of the object by calculating the intersection point of the line segment of h_2 and the line segments of h_3 and h_4. As a result, the specifying unit 14 can minimize the number of line segments to be used for calculating the intersection point.

Alternatively, as for the object hi (i is an integer of 1 to 6), the specifying unit 14 extracts an object having a higher ranking than hi at the time when the certainty factor is 0 or an object having a higher ranking than h_i at the time of the certainty factor 1. Further, the specifying unit 14 may extract, from the extracted object, the object excluding the object having a higher ranking than h_i at the time when the certainty factor is 0 and 1.

For example, with respect to h_1, h_3 is extracted as an object having a higher ranking than h_1 at the time when the certainty factor is 0 or an object having a higher ranking than h_1 at the time when the certainty factor is 1. As for h_1, there is no object with a higher ranking than h_1 at the time points of the certainty factors 0 and 1. Therefore, h_3 is extracted for h_1.

As for h_2, h_1, h_3, and h_4 are extracted as an object having a higher ranking than h_2 at the time when the certainty factor is 0 or an object having a higher ranking than h_2 at the time of when the certainty factor is 1. In addition, h_1 is an object having a higher ranking than h_2 at the time points of the certainty factors 0 and 1. Therefore, as for h_2, h_3 and h_4 acquired by excluding h_1 from the h_1, h_3, and h_4 are extracted.

As for h_3, h_1 and h_2 are extracted as an object having a higher ranking than h_3 at the time when the certainty factor is 0 or an object having a higher ranking than h_3 at the time when the certainty factor is 1. As for h_3, there is no object having a higher ranking than h_3 at the time points of the certainty factors 0 and 1. Therefore, h_i and h_2 are extracted for h_3.

As for h_4, h_1, h_2, and h_3 are extracted as an object having a higher ranking than h_4 at the time when the certainty factor is 0 or an object having a higher ranking than h_4 at the time of the certainty factor 1. In addition, h_1 and h_3 become objects higher than h_4 at the time points of certainty factors 0 and 1. Therefore, h_2 is extracted for h_4.

As for h_5 and h_6, no object is extracted.

In this way, the specifying unit 14 may calculate the intersection point in a certain line segment. For example, when calculating the intersection point of h_1, the specifying unit 14 calculates the intersection point of the line segment with h_3 extracted in association with h_1. When calculating the intersection point of h_3, the specifying unit 14 calculates the intersection points of the line segments of h_1 and h_2 extracted in association with h_3. Thus, the specifying unit 14 can also calculate the intersection point of any line segments.

The display control unit 15 generates display data in such a way that the certainty factor of the intersection point selected by the specifying unit 14 is displayed on the slide bar of the search condition designating region 32 in FIG. 5. Further, the display control unit 15 outputs display data to the display device 30, and the display device 30 displays the received display data.

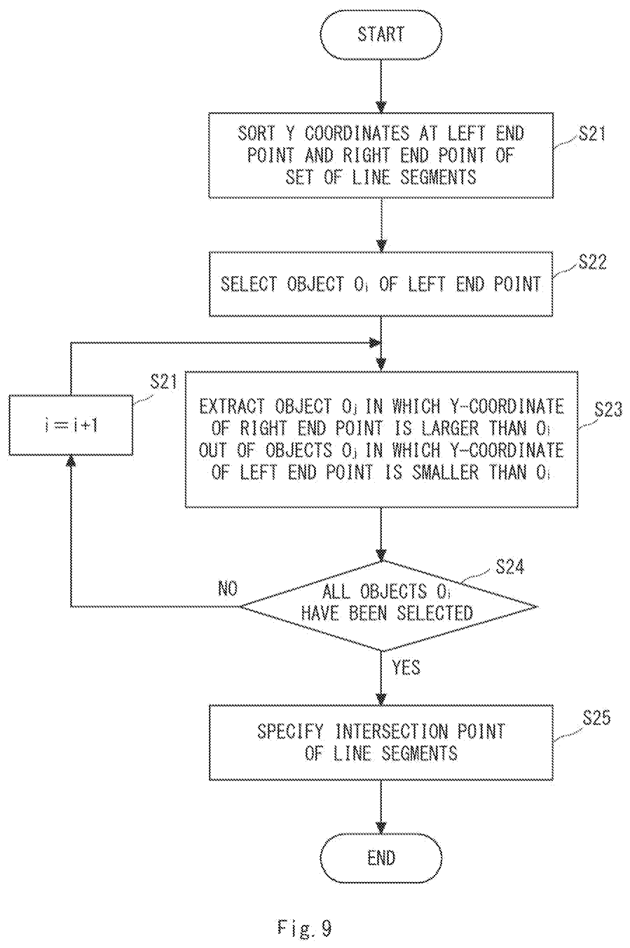

Herein, a flow of processing of specifying the intersection point of line segments according to the second example embodiment will be explained with reference to FIG. 9. First, the sorting unit 13 sorts y coordinates at the left end point and the right end point of each line segment in FIG. 7 (S21). Specifically, in FIG. 7, the sorting unit 13 sorts the y-coordinate of each line segment with a certainty factor of 0 as the left end point, and sorts the y-coordinate of each line segment with a certainty factor of 1 as the right end point.

Next, the specifying unit 14 selects a target Oᵢ of the left end point (S22). The specifying unit 14 may select the target Oᵢ in descending order of the y-coordinate value, i.e., in descending order of the scores. In other words, the specifying unit 14 may first select the most highly scored target O₁.

Next, the specifying unit 14 extracts a target Oⱼ in which the y-coordinate of the right end point is larger than the Oᵢ, among the targets Oⱼ in which the y-coordinate of the left end point is smaller than the Oᵢ (S23). Next, the specifying unit 14 determines whether all the Oᵢ of the left end point have been selected (S24). When all the Oᵢ of the left end point have not been selected, the specifying unit 14 sets i=i+1 and repeats processing subsequent to step S23. When all the Oᵢ of the left end point are selected, the specifying unit 14 specifies the intersection point of the line segments with respect to the selected Oᵢ from which the target Oⱼ is extracted (S25).

Herein, in step S23, the specifying unit 14 may extract, for the object Oᵢ, the object Oⱼ having a higher ranking than the Oᵢ at the time when the certainty factor is 0 or an object Oₖ having a higher ranking than the Oᵢ at the time when the certainty factor is 1. Further, the specifying unit 14 may extract, from among the Oⱼ and the Oₖ, an object excluding an object Oₘ having a higher ranking than the Oᵢ at the time points of the certainty factors 0 and 1.

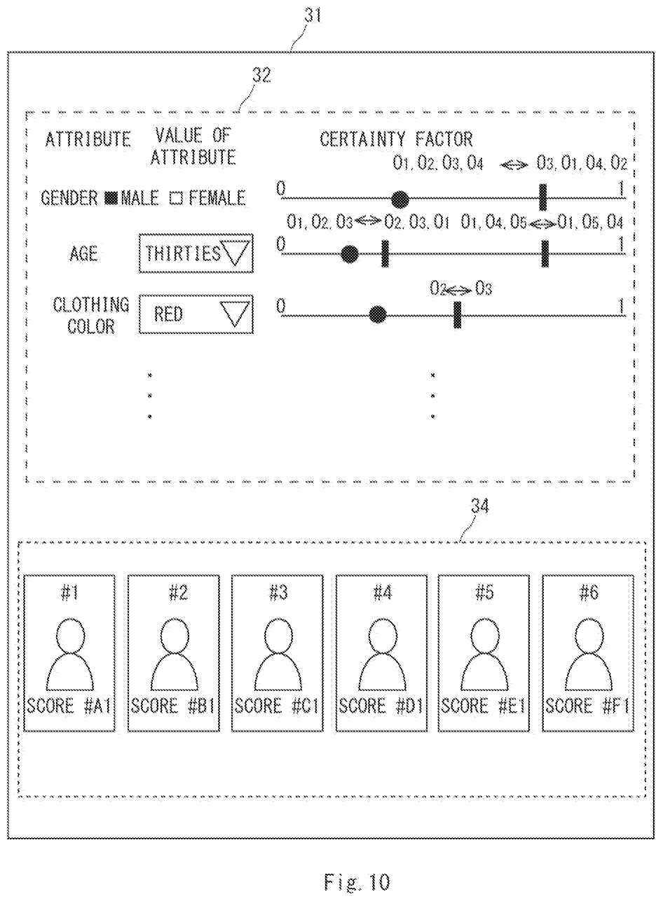

Herein, the threshold value of the certainty factor in the screen image in FIG. 5 may be illustrated as in FIG. 10. The threshold value of certainty factor illustrated in FIG. 10 is collectively displayed for threshold values of a plurality of the certainty factors illustrated in FIG. 5. In other words, as illustrated in FIG. 10, the display control unit 15 may not display the threshold values of all the certainty factors specified by the specifying unit 14, but may display the threshold values by narrowing down to some threshold values.

As explained above, the information processing apparatus 20 according to the second example embodiment can specify the threshold value of the certainty factor for changing an order of the objects displayed in the result display region 34 when the certainty factor of the attribute designated as the search condition is changed. Further, the information processing apparatus 20 displays the threshold value of the certainty factor in the search condition designating region 32, whereby the user can use the threshold value of the certainty factor when analyzing the relevance between the certainty factor and the search result.

Further, even when a plurality of attributes are designated as search conditions, the information processing apparatus 20 can display the threshold value of the certainty factor in the search condition designating region 32 for each attribute. In this way, the user can analyze the relevance between the certainty factor and the search result in more detail.

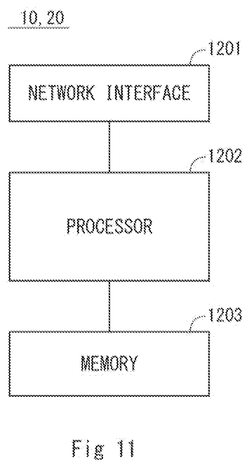

FIG. 11 is a block diagram illustrating a configuration example of the information processing apparatus 10 and the information processing apparatus 20 (hereinafter, referred to as the information processing apparatus 10 and the like). Referring to FIG. 11, the information processing apparatus 10 and the like include a network interface 1201, a processor 1202, and a memory 1203. The network interface 1201 may be used for communication with a network node (e.g., eNB, MME, P-GW,). The network interface 1201 may include, for example, a network interface card (NIC) conforming to the IEEE 802.3 series. Herein, eNB represents evolved Node B, MME represents Mobility Management Entity, and P-GW represents Packet Data Network Gateway. IEEE represents Institute of Electrical and Electronics Engineers.

The processor 1202 reads and executes software (computer program) from the memory 1203, thereby performing processing of the information processing apparatus 10 and the like explained with reference to the flowcharts in the above-described example embodiments. The processor 1202 may be, for example, a microprocessor, an MPU, or a CPU. The processor 1202 may include a plurality of processors.

The memory 1203 is constituted of a combination of a volatile memory and a nonvolatile memory. The memory 1203 may include a storage that is placed apart from the processor 1202. In this case, the processor 1202 may access the memory 1203 via an Input/Output (I/O) interface, which is not illustrated.

In the example of FIG. 11, the memory 1203 is used for storing a group of software modules. The processor 1202 reads and executes the group of software modules from the memory 1203, thereby enabling to perform the processing of the information processing apparatus 10 and the like explained in the above-described example embodiments.

As explained with reference to FIG. 11, each of the processors included in the information processing apparatus 10 and the like in the above-described example embodiments executes one or a plurality of programs including a group of instructions for causing a computer to execute the algorithms explained with reference to the drawings.

In the examples described above, the program includes a group of instructions (or software codes) that, when loaded into a computer, causes the computer to perform one or more of the functions explained in the example embodiments. The program may be stored in a non-transitory computer-readable medium or a tangible storage medium. Examples of the computer-readable media or tangible storage media include, not for limitation, a random-access memory (RAM), a read-only memory (ROM), a flash memory, a solid-state drive (SSD) or other memory technology, a CD-ROM, a digital versatile disc (DVD), a Blu-ray (registered trademark) disc or other optical disk storages, a magnetic cassette, a magnetic tape, and a magnetic disk storage or other magnetic storage devices. The program may be transmitted on a transitory computer-readable medium or a communication medium. Examples of the transitory computer-readable medium or communication medium include, not for limitation, electric, optical, acoustic, or other forms of propagated signals.

The present disclosure is not limited to the above-described example embodiments, and can be modified as appropriate without departing from the scope and spirit of the present disclosure.

Some or all of the above-described example embodiments may also be described as the following supplementary notes, but are not limited to the following.

### Supplementary Note 1

An information processing apparatus comprising:
management means for managing a plurality of objects, at least one attribute by which each of the objects is classified, and a certainty factor indicating a probability that the object has the attribute in association with one another;
calculation means for using an attribute designated as a search condition, a certainty factor that can be designated as a search condition for the attribute, and a certainty factor being managed in association with an attribute identical or similar to the attribute designated as the search condition, and thereby calculating a score indicating a matching degree of the object with respect to the search condition;
sorting means for sorting the scores and arranging the plurality of objects in order of sorted scores;
specifying means for specifying a certainty factor that changes an order of the objects, based on a shift in the scores of the plurality of objects that change depending on a shift in a certainty factor that can be designated as the search condition; and
display control means for generating display data for displaying an attribute designated as the search condition and a certainty factor that changes an order of the objects in association with each other.

### Supplementary Note 2

The information processing apparatus according to supplementary note 1, wherein the specifying means indicates a shift in a score in each object with respect to a shift in a certainty factor that can be designated as the search condition, by using a line segment, and specifies a certainty factor associated with an intersection point of intersecting line segments as a certainty factor that changes an order of the object.

### Supplementary Note 3

The information processing apparatus according to supplementary note 2, wherein the specifying means specifies an intersecting line segment by comparing an order of the object when a first certainty factor is designated and an order of the object when a second certainty factor is designated, in a case where the search condition can be designated from the first certainty factor to the second certainty factor.

### Supplementary Note 4

The information processing apparatus according to supplementary note 3, wherein the specifying means specifies that a line segment associated with an object included in both of an object having a lower score than a first object among the plurality of objects when the first certainty factor is designated and an object having a higher score than the first object when the second certainty factor is designated intersects a line segment associated with the first object.

### Supplementary Note 5

The information processing apparatus according to supplementary note 3, wherein the specifying means specifies that a line segment associated with a remaining object intersects a line segment associated with a first object, the remaining object excluding an object having a higher score than the first object in the first certainty factor and the second certainty factor, among an object having a higher score than the first object among the plurality of objects in the first certainty factor, or an object having a higher score than the first object in the second certainty factor.

### Supplementary Note 6

The information processing apparatus according to any one of supplementary notes 1 to 5, wherein, when a first attribute and a second attribute are designated as the search condition, the specifying means defines a certainty factor of the second attribute, and specifies a first certainty factor that changes an order of the objects, based on a shift in scores, of the plurality of objects that change depending on a shift in the first certainty factor relating to the first attribute.

### Supplementary Note 7

The information processing apparatus according to supplementary note 6, wherein the first certainty factor that changes an order of the objects changes depending on a change in certainty factor of the second attribute.

### Supplementary Note 8

The information processing apparatus according to any one of supplementary notes 1 to 7, wherein the display control means generates display data for displaying a plurality of objects arranged in an order of scores, based on an attribute designated as a search condition and a certainty factor designated as a search condition for the attribute.

### Supplementary Note 9

An analysis system comprising
an information processing apparatus including: management means for managing a plurality of objects, at least one attribute by which each of the objects is classified, a certainty factor indicating a probability that the object has the attribute in association with one another; calculation means for using an attribute designated as a search condition, a certainty factor that can be designated as a search condition for the attribute, and a certainty factor being managed in association with an attribute identical or similar to an attribute designated as the search condition, and thereby calculating a score indicating a matching degree of the object with respect to the search condition; sorting means for sorting the scores and arranging the plurality of objects in order of sorted scores; specifying means for specifying a certainty factor that changes an order of the objects, based on a shift in scores of the plurality of objects that change depending on a shift in a certainty factor that can be designated as the search condition; and display control means for generating display data for displaying an attribute designated as the search condition and a certainty factor that changes an order of the objects in association with each other, and
a display device configured to display the display data.

### Supplementary Note 10

The analysis system according to claim 9, wherein
the display control means generates display data for displaying a plurality of objects arranged in order of scores, based on an attribute designated as a search condition and a certainty factor designated as a search condition for the attribute, and
the display device displays the display data.

### Supplementary Note 11

A data generation method comprising:
managing a plurality of objects, at least one attribute by which each of the objects is classified, and a certainty factor indicating a probability that the object has the attribute in association with one another;
using an attribute designated as a search condition, a certainty factor that can be designated as a search condition for the attribute, and a certainty factor being managed in association with an attribute identical or similar to an attribute designated as the search condition, and thereby calculating a score indicating a matching degree of the object with respect to the search condition;
sorting the scores, and arranging the plurality of objects in order of sorted scores;
specifying a certainty factor that changes an order of the objects, based on a shift in scores of the plurality of objects that change depending on a shift in a certainty factor that can be designated as the search condition; and
generating display data for displaying an attribute designated as the search condition and a certainty factor that changes an order of the objects in association with each other.

### Supplementary Note 12

A non-transitory computer-readable medium storing a program causing a computer to execute:
managing a plurality of objects, at least one attribute by which each of the objects is classified, and a certainty factor indicating a probability that the object has the attribute in association with one another;
using an attribute designated as a search condition, a certainty factor that can be designated as a search condition for the attribute, and a certainty factor being managed in association with an attribute identical or similar to an attribute designated as the search condition, and thereby calculating a score indicating a matching degree of the object with respect to the search condition;
sorting the scores, and arranging the plurality of objects in order of sorted scores;
specifying a certainty factor that changes an order of the objects, based on a shift in scores of the plurality of objects that change depending on a shift in a certainty factor that can be designated as the search condition; and
generating display data for displaying an attribute designated as the search condition and a certainty factor that changes an order of the objects in association with each other.

The present invention is not limited to the above-described example embodiments, and can be modified as appropriate without departing from the scope and spirit of the present invention.

### REFERENCE SIGNS LIST

10 INFORMATION PROCESSING APPARATUS
11 MANAGEMENT UNIT
12 CALCULATION UNIT
13 SORTING UNIT
14 SPECIFYING UNIT
15 DISPLAY CONTROL UNIT
20 INFORMATION PROCESSING APPARATUS
21 SEARCH CONDITION ACQUISITION UNIT
30 DISPLAY DEVICE
31 DISPLAY SCREEN
32 SEARCH CONDITION DESIGNATING REGION
34 RESULT DISPLAY REGION

What is claimed is:

1. An information processing apparatus comprising:
at least one memory storing instructions, and
at least one processor configured to execute the instructions to;
manage a plurality of objects, at least one attribute by which each of the objects is classified, and a certainty factor indicating a probability that the object has the attribute in association with one another;
use an attribute designated as a search condition, a certainty factor that can be designated as a search condition for the attribute, and a certainty factor being managed in association with an attribute identical or similar to the attribute designated as the search condition, and thereby calculating a score indicating a matching degree of the object with respect to the search condition;
sort the scores and arranging the plurality of objects in order of sorted scores;
specify a certainty factor that changes an order of the objects, based on a shift in the scores of the plurality of objects that change depending on a shift in a certainty factor that can be designated as the search condition; and
generate display data for displaying an attribute designated as the search condition and a certainty factor that changes an order of the objects in association with each other.

2. The information processing apparatus according to claim 1, wherein the at least one processor is further configured to execute the instructions to indicate a shift in a score in each object with respect to a shift in a certainty factor that can be designated as the search condition, by using a line segment, and specifies a certainty factor associated with an intersection point of intersecting line segments as a certainty factor that changes an order of the object.

3. The information processing apparatus according to claim 2, wherein the at least one processor is further configured to execute the instructions to specify an intersecting line segment by comparing an order of the object when a first certainty factor is designated and an order of the object when a second certainty factor is designated, in a case where the search condition can be designated from the first certainty factor to the second certainty factor.

4. The information processing apparatus according to claim 3, wherein the at least one processor is further configured to execute the instructions to specify that a line segment associated with an object included in both of an object having a lower score than a first object among the plurality of objects when the first certainty factor is designated and an object having a higher score than the first object when the second certainty factor is designated intersects a line segment associated with the first object.

5. The information processing apparatus according to claim 3, wherein the at least one processor is further configured to execute the instructions to specify that a line segment associated with a remaining object intersects a line segment associated with a first object, the remaining object excluding an object having a higher score than the first object in the first certainty factor and the second certainty factor, among an object having a higher score than the first object among the plurality of objects in the first certainty factor, or an object having a higher score than the first object in the second certainty factor.

6. The information processing apparatus according to claim 1, wherein, when a first attribute and a second attribute are designated as the search condition, the at least one processor is further configured to execute the instructions to define a certainty factor of the second attribute, and specifies a first certainty factor that changes an order of the objects, based on a shift in scores, of the plurality of objects that change depending on a shift in the first certainty factor relating to the first attribute.

7. The information processing apparatus according to claim 6, wherein the first certainty factor that changes an order of the objects changes depending on a change in certainty factor of the second attribute.

8. The information processing apparatus according to claim 1, wherein the at least one processor is further configured to execute the instructions to generate display data for displaying a plurality of objects arranged in an order of scores, based on an attribute designated as a search condition and a certainty factor designated as a search condition for the attribute.

9-10. (cancled)

11. A data generation method comprising:
managing a plurality of objects, at least one attribute by which each of the objects is classified, and a certainty factor indicating a probability that the object has the attribute in association with one another;
using an attribute designated as a search condition, a certainty factor that can be designated as a search condition for the attribute, and a certainty factor being managed in association with an attribute identical or similar to an attribute designated as the search condition, and thereby calculating a score indicating a matching degree of the object with respect to the search condition;
sorting the scores, and arranging the plurality of objects in order of sorted scores;
specifying a certainty factor that changes an order of the objects, based on a shift in scores of the plurality of objects that change depending on a shift in a certainty factor that can be designated as the search condition; and
generating display data for displaying an attribute designated as the search condition and a certainty factor that changes an order of the objects in association with each other.

12. A non-transitory computer-readable medium storing a program causing a computer to execute:
managing a plurality of objects, at least one attribute by which each of the objects is classified, and a certainty factor indicating a probability that the object has the attribute in association with one another;
using an attribute designated as a search condition, a certainty factor that can be designated as a search condition for the attribute, and a certainty factor being managed in association with an attribute identical or similar to an attribute designated as the search condition, and thereby calculating a score indicating a matching degree of the object with respect to the search condition;
sorting the scores, and arranging the plurality of objects in order of sorted scores;
specifying a certainty factor that changes an order of the objects, based on a shift in scores of the plurality of objects that change depending on a shift in a certainty factor that can be designated as the search condition; and
generating display data for displaying an attribute designated as the search condition and a certainty factor that changes an order of the objects in association with each other.
